(19) United States
(12) Patent Application Publication
(10) Pub. No.: US 2009/0015029 A1
(43) Pub. Date: Jan. 15, 2009

(54) Insulation Arrangement

(75) Inventors: Bernd Nabert, Schopfloch (DE); Erwin Lutz, Schwieberdingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/145,027

(22) Filed: Jun. 24, 2008

(30) Foreign Application Priority Data
Jul. 13, 2007 (DE) 10 2007 032 728.7

(51) Int. Cl. B60R 13/08

(52) U.S. Cl. 296/39.3

(57) ABSTRACT

An insulation configuration in a motor vehicle has an insulation element, in particular a sound insulating molded part, which has at least two layers, of which at least one is formed as an insulation layer and one is formed as a support layer. A sealing profile is provided, by which the insulation element is connected with a marginal area to a body of a motor vehicle. The insulation element has, in its marginal area which is in connection with the sealing profile, a cross section thickening, which engages in an undercut-like recess of the sealing profile, and is fixed there.

### CROSS-REFERENCE TO RELATED APPLICATION

This application claims the priority, under 35 U.S.C. § 119, of German application DE 10 2007 032 728.7, filed Jul. 13, 2007; the prior application is herewith incorporated by reference in its entirety.

### BACKGROUND OF THE INVENTION

Field of the Invention

The present invention relates to an insulation configuration in a motor vehicle with an insulation element, particularly with a sound insulation molded part. The insulation element has at least two layers of which at least one is formed as an insulation layer and one is formed as a support layer.

From published, non-prosecuted German patent application DE 39 09 389 A1, a generic sound insulation is known, which is formed of a foam layer and a heavy layer. The sound insulation is disposed between an instrument panel and a front-wall upper part of a passenger car, and, in its front marginal area, it has a convex curvature which is applied with resilience and thus in a sound-proof way against a rubber-elastic seal.

From German patent DE 10 2005 056 840 B3, a sound insulation part and a method for its manufacture are known. The sound insulation part is formed of a sound absorbing layer and at least one heavy layer that is directly connected to the former layer by a substance connection. The heavy layer is here configured as a microporous sprayed skin, and it presents at least one air permeable and at least one air impermeable partial surface area.

Sound insulations in motor vehicles are of increasing significance because they play a crucial role in determining the comfort of driving a motor vehicle. Besides the configuration of the sound insulation, its connection to the car body is also of special importance, because sound bridges, for example, can form here, which are opposed to the notion of sound insulation. In addition, the connection between the sound insulation and the body of the motor vehicle should be easy to manufacture, respectively to install, and in addition it should be configured so it is permanent and so that the sound insulating effect is maintained preferably for the entire life of the motor vehicle.

### SUMMARY OF THE INVENTION

It is accordingly an object of the invention to provide an insulation configuration which overcomes the above-mentioned disadvantages of the prior art devices of this general type, which is improved or at least a different embodiment that is characterized by a connection to the body, which is effective from the point of view of sound technology, and permanent.

With the foregoing and other objects in view there is provided, in accordance with the invention, an insulation configuration in a motor vehicle. The insulation configuration contains an insulation element being a sound insulating molded part and has at least two layers. The two layers include a first layer being an insulation layer and a second layer being a support layer. The insulation element further has a marginal area. A sealing profile is provided for connecting the insulation element via the marginal area to a car body element of the motor vehicle. The sealing profile has an undercut-shaped recess formed therein. The insulation element has in the marginal area, being in connection with the sealing profile, a cross section thickening, engaging in the undercut-shaped recess of the sealing profile, and is fixed there.

The invention is based on the general notion of holding an insulation element by the margin using a sealing profile, and to fix it by this sealing profile at the same time to a body of a motor vehicle. To be able to establish a permanent connection between the body, on the one hand, and the insulation element, on the other hand, the insulation element has, in its marginal area which is in connection with the sealing profile, a cross section thickening which engages in an undercut-like recess of the sealing profile and can thus be held reliably and permanently in the sealing profile. However, the undercut-like connection according to the invention between the insulation element and the sealing profile does not only guarantee the reliable fixation of the insulation element in the sealing profile, rather, it also ensures a simple installation of the insulation element on the sealing profile, or vice versa. With the insulation configuration according to the invention, it is thus possible to achieve efficiency effects in the installation process, and, at the same time, it is possible to reliably mount the insulation element preferably along its entire marginal area on the body, where the sealing profile reliably prevents the transmission of sound between the body and the insulation element.

The sealing profile has advantageously a U-shaped recess, in which, in the installed state, the marginal area of the insulation element, which is thickened in cross section, as well as the marginal area of a car body element, are accommodated together. The U-shaped recess thus acts as a clamp, which clamps between its U arms both the marginal area of the car body element and also the marginal area of the insulation element. In such an installation, the insulation element is aligned in such a way that it is applied with its sound insulation layer, for example, a polyurethane soft foam layer, against the car body element, so that usually no sound transmission between the car body element and the insulation element occurs. Alternatively, the sealing profile can also present at least two U-shaped recesses, where one U-shaped recess receives the marginal area of the insulation element, which is thickened in cross section, and the other receives the marginal area of the car body element. In a sealing profile that has been configured in this way, there is no direct contact between the insulation element and the car body element, so that a direct sound transmission is completely prevented.

In another advantageous embodiment of the solution according to the invention, at least one of the U-shaped recesses has holding contours that are directed inward, and work in collaboration with the marginal area of the insulation element and/or the marginal area of the car body element. Such holding contours can be configured, for example, like an engagement lug or engagement lip, allowing an undercut-like connection, particularly with the marginal area of the insulation element, which is thickened in cross section. Such holding contours also ensure a reliable holding of the insulation element, respectively of the marginal area of the car body element, in the sealing profile, resulting in a permanent connection between the two components. In spite of the reliable connection, the insulation element can be pulled out with appropriate force exertion in a relatively simple way from the elastic sealing profile, particularly from the elastic U-shaped recess, so that the process of removing the insulation element is also configured relatively simply.

The cross section thickening is formed advantageously in the area of the support layer. The cross section thickening can be formed, for example, like a marginal lug, which is molded, respectively injection molded, in a simple way on the support layer, or which is manufactured in a single work step together with the support layer. As a result of the cross section thickening formed on the support layer, a stiffening is achieved additionally, particularly a peripheral marginal stiffening of the insulation element, which has a positive effect on the sound insulation properties of the insulation element.

In another advantageous embodiment of the solution according to the invention, the layers of the insulation element, that is to say, for example, the support layer and the insulation layer, are pressed together in the installed sealing profile in the marginal area of the insulation layer. In this case, the at least two U arms of the U-shaped recess of the sealing profile exert a clamping force on the marginal area of the insulation element, which provides additional support for a secure holding of the insulation element in the sealing profile.

Other features which are considered as characteristic for the invention are set forth in the appended claims.

Although the invention is illustrated and described herein as embodied in an insulation configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1A is a diagrammatic, cross-sectional view through a first embodiment of an insulation configuration according to the invention;

FIG. 1B is a diagrammatic, cross-sectional view through a second embodiment of an insulation configuration according to the invention; and

FIG. 2 is a diagrammatic, perspective view of an insulation configuration disposed in an area of the convertible top storage compartment.

### DETAILED DESCRIPTION OF THE INVENTION

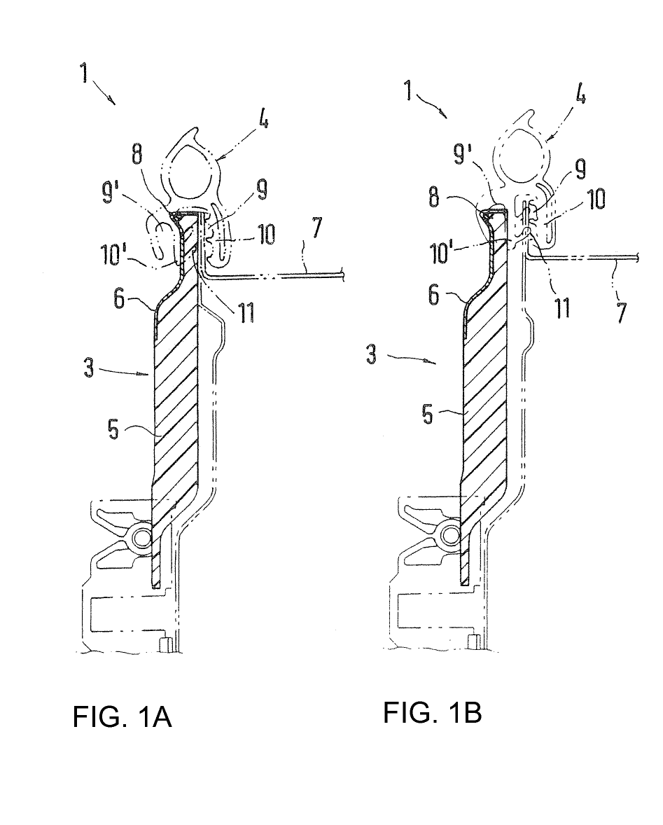

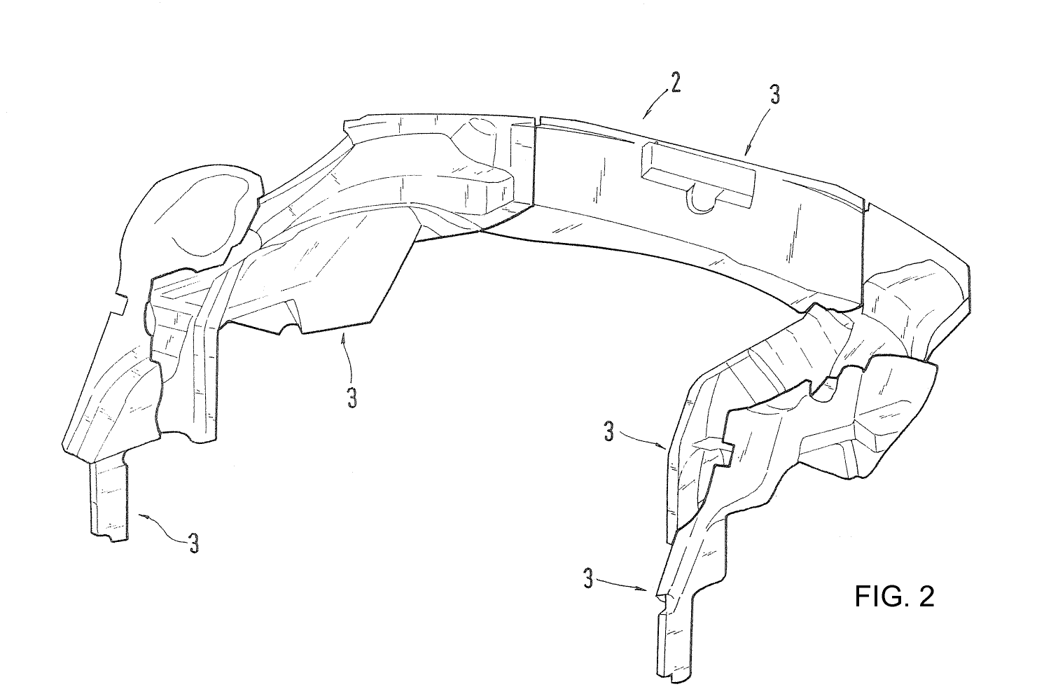

Referring now to the figures of the drawing in detail and first, particularly, to FIGS. 1A and 1B thereof, there is shown an insulation configuration 1 according to the invention, which is disposed, for example, in an area of a convertible top storage compartment 2 (see FIG. 2). The insulation configuration 1 has an insulation element 3 as well as a sealing profile 4. The insulation element 3 has at least two layers 5, 6, of which at least one is configured as an insulation layer 5 and one as a support layer 6. The support layer 6 can here have a thickness of, for example, 0.25-0.5 mm, and be made from polyurethane, particularly from a polyurethane sprayed skin. Usually, the support layer 6 is also referred to as the heavy layer. In contrast, the insulation layer 5, which is usually substantially thicker than the support layer 6, is usually made of polyurethane soft foam.

To connect the insulation element 3 to a car body element 7 of the motor vehicle, the sealing profile 4 is provided, which receives a marginal area of the insulation element 3 as well as a marginal area of the body part 7. To be able to ensure a reliable fixation of the insulation element 3 on the car body element 7, the insulation element 3 has, in its marginal area, a cross section thickening 8, which engages in an undercut-shaped recess 9 of the sealing profile 4 and is fixed thereby.

In general, the sealing profile has two U-shaped recesses 9 and 9′, where, in the variant represented in FIG. 1A, the marginal area of the insulation element 3 as well as the marginal area of the car body element 7 are received together in the recess 9 of the sealing profile 4. Alternatively, it is also conceivable for the marginal area of the car body element 7 to be fixed in the recess 9 and for the marginal area of the insulation element 3 to be fixed in the recess 9′ of the sealing profile 4 (FIG. 1B).

The recess 9 of the sealing profile 4 according to FIG. 1A is, as described in the previous paragraph, configured as a U-shaped recess 9, and it has two U arms 10, 10′, which clamp the marginal areas of the car body element 7 and of the insulation element 3 between themselves. For the additional fixation of the marginal area of the insulation element 3, the U arm 10′ has holding contours 11 that are directed inward, and work together with the marginal area of the insulation element 3. Similar holding contours are also disposed on the other U arm 10, where they work together with the marginal area of the car body element 7. Naturally, it is also conceivable for the marginal area of the car body element 7 to present a cross section thickening as well, and thus work in collaboration, in an undercut-like way, with the sealing profile 4.

In the embodiment shown in FIG. 1B, in which the marginal areas of the insulation element 3 and of the car body element 7 engage in different recesses 9 and 9′, it is naturally possible to provide corresponding holding contours 11 on both recesses 9, 9′.

Advantageously, at least one of the holding contours 11 is configured as an engagement lug or as an engagement lip, which engages with the cross section thickening 8 of the marginal area of the insulation element 3 and/or with the marginal area of the car body element 7. The cross section thickening 8 is here formed, according to the example shown in FIGS. 1A and 1B, on the support layer 6; in particular, it is manufactured to form one piece with the support layer 6, and thus it offers the great advantage of additionally stiffening the insulation element 3 at the margin.

To minimize the transmission of sound between the insulation element 3 and the car body element 7, respectively, or to prevent it entirely if possible, the insulation element 3, in the variant represented in FIG. 1A, is fixed with its insulation layer 5, which is preferably pressed together in the marginal area, on the car body element 7. In a variant, in which the marginal area of the car body element 7 and the marginal area of the insulation element 3 engage in different recesses 9 and 9′ on the sealing profile 4, an uncoupling, in terms of insulation technology, would already occur due to the U arm 10′, and the sound transmission would at least be made more difficult.

In FIG. 2, possible insulation elements 3 are represented, which are disposed in an area of the convertible top storage compartment 2 of a cabriolet, which is not represented further. It is apparent here that the insulation configurations 1 according to the invention can be disposed at many different places of a motor vehicle, and that they can thus cover a broad spectrum of applications.

1. An insulation configuration in a motor vehicle, the insulation configuration comprising:
an insulation element being a sound insulating molded part and having at least two layers, said two layers including a first layer being an insulation layer and a second layer being a support layer, said insulation element further having a marginal area;
a sealing profile for connecting said insulation element via said marginal area to a car body element of the motor vehicle, said sealing profile having an undercut-shaped recess formed therein; and
said insulation element having in said marginal area, being in connection with said sealing profile, a cross section thickening, engaging in said undercut-shaped recess of said sealing profile, and being fixed there.

2. The insulation configuration according to claim 1, wherein said support layer has a thickness in a range of approximately 0.25-0.5 mm and is made of polyurethane and said insulation layer is made of a polyurethane soft foam and is thicker than said support layer.

3. The insulation configuration according to claim 1, wherein the insulation configuration is provided in an area of a convertible top storage compartment.

4. The insulation configuration according to claim 1, wherein said undercut-shaped recess is a U-shaped recess, in which, in an installed state, at least one of said marginal area of said insulation element, being thickened in cross section, and a marginal area of the car body element are received together.

5. The insulation configuration according to claim 1, wherein said undercut-shaped recess is one of at least two U-shaped recesses formed in said sealing profile, where, in an installed state, said marginal area of said insulation element, being thickened in cross section, is received in a first recess of said recesses, and a marginal area of the car body element is received in a second recess of said recesses.

6. The insulation configuration according to claim 5, wherein at least one of said U-shaped recesses has holding contours directed inward and work in collaboration with at least one of said marginal area of said insulation element and the car body element.

7. The insulation configuration according to claim 6, wherein at least one of said holding contours is one of an engagement lug and an engagement lip and engages with at least one of said cross section thickening of said marginal area of said insulation element and with the marginal area of the car body element.

8. The insulation configuration according to claim 1, wherein said cross section thickening is formed in an area of said support layer.

9. The insulation configuration according to claim 1, wherein said two layers of said insulation element, in said marginal area of said insulation element, are pressed together when said sealing profile is installed.

10. The insulation configuration according to claim 4, wherein said U-shaped recess has holding contours directed inward and work in collaboration with at least one of said marginal area of said insulation element and the car body element.

11. The insulation configuration according to claim 10, wherein at least one of said holding contours is one of an engagement lug and an engagement lip and engages with at least one of said cross section thickening of said marginal area of said insulation element and with the marginal area of the car body element.

12. A motor vehicle, comprising:
an insulation configuration, containing:
an insulation element being a sound insulating molded part and having at least two layers, said two layers including a first layer being an insulation layer and a second layer being a support layer, said insulation element further having a marginal area;
a sealing profile for connecting said insulation element via said marginal area to a car body element of the motor vehicle, said sealing profile having an undercut-shaped recess formed therein; and
said insulation element having in said marginal area, being in connection with said sealing profile, a cross section thickening, engaging in said undercut-shaped recess of said sealing profile, and being fixed there.
